(19) United States
(12) Patent Application Publication
(10) Pub. No.: US 2026/0037008 A1
(43) Pub. Date: Feb. 5, 2026

(54) ENVIRONMENTAL MONITORING USING AUTONOMOUS SYSTEMS AND ARTIFICIAL INTELLIGENCE

(71) Applicant: NVIDIA Corporation, Santa Clara, CA (US)

(72) Inventors: Wangren XU, San Jose, CA (US); Robin JENKIN, Morgan Hill, CA (US)

(21) Appl. No.: 18/669,723

(22) Filed: May 21, 2024

(51) Int. Cl. G05D 1/86; G05B 13/02; G05D 101/15; G05D 105/80; G07C 5/00; G07C 5/08

(52) U.S. Cl. CPC G05D 1/86; G05B 13/027; G07C 5/008; G05D 2101/15; G05D 2105/80; G07C 5/085

(57) ABSTRACT

Machines, such as those that perform autonomous or semi-autonomous operations, obtain sensor data that is used for the performance of control operations related to performance of the autonomous or semi-autonomous operations. Such sensor data may also include information that may be useful for applications and contexts outside of the performance of such control operations (“ancillary purposes”). Systems and methods of the present disclosure accordingly relate to analyzing, using, transmitting, processing, etc. of such sensor data for such ancillary purposes. For instance, such systems and methods may relate to processing, using an artificial intelligence (AI) model, the sensor data obtained using sensors of a machine and that is used for control operations to also identify one or more features of an environment of the machine in a manner that is ancillary to the control operations.

### BACKGROUND

Systems, subsystems, and machines may leverage various sensors (e.g., cameras, LiDAR, RADAR, ultrasonic, etc.) to obtain data to inform the performance of various operations—such as operations related to perception, localization, control, actuation, navigation, etc. For example, autonomous and/or semi-autonomous systems (e.g., ego-machines) may be designed to perform autonomous or semi-autonomous operations based on sensor data obtained using one or more sensors.

One or more traditional approaches to environmental monitoring includes surveying performed by one or more humans and/or analyzing data obtained from sensors in fixed locations, etc. However, limitations of such approaches include being labor intensive, time-consuming, limited in coverage, and/or susceptible to human bias/error. These limitations are increased in systems monitoring environments that are large, remote, inhospitable, etc.

### SUMMARY

According to one or more embodiments of the present disclosure, one or more perception operations, localization operations, mapping operations, communications operations, etc. related to a machine may be performed based on sensor data obtained using one or more sensors.

In some embodiments, resource data of the machine and/or a computing system communicatively coupled to the machine may be used for various determinations. For instance, resource data may include power/battery levels, fuel levels, engine temperature, tire pressure, oil levels, brake fluid levels, etc. The resource data of the machine computing system may include power/battery levels, available memory, disk space, network bandwidth, temperature, system load average, etc. In these and other embodiments, the resource data may be used to determine when the machine may process, use, analyze, transmit, etc. sensor data for purposes ancillary to performing control operations. Additionally or alternatively, the resource data may be used to determine when the machine communicates sensor data obtained from the sensors to an analyzing module and/or a remote server (e.g., an edge server). For example, the sensor may be used to process, use, analyze, and/or transmit sensor data of one or more features of the environment of the machine in response to the resource data satisfying a threshold indicating that the machine and/or the computing system may perform various control operations as intended.

In some embodiments, in response to determining that the resource data satisfies a threshold with respect to performing the control operations related to the machine, sensor data may be used, processed, and/or analyzed in a manner that is ancillary to the performance of such control operations. In these and other embodiments, the sensor data may indicate one or more features of an environment of the machine (e.g., environmental features). In some embodiments, the sensor data may include an environmental feature of interest as sensor data is obtained during routine performance of control operations by the machine. Additionally or alternatively, the sensors may be configured to obtain specific sensor data of environmental features that are ancillary to the machine performing the control operations.

In some embodiments, the sensor data may be processed using an AI model, ancillary to performing various control operations, to identify one or more aspects of the one or more environmental features. For example, an AI model may accurately and efficiently identify environmental features, track changes to the environmental features over time, etc. In some embodiments, the AI model may include a machine learning (ML) model, a neural network, a large language model (LLM), and/or a vision language model (VLM).

Embodiments of the present disclosure may increase an ability of a system to monitor one or more environmental features based on sensor data from performing tracking that is ancillary to performing the control operations of the machine (e.g., ancillary tracking). Further, in some embodiments, by using the AI model to perform ancillary tracking, one or more systems may increase their effectiveness in monitoring the current condition of the environment, changes over time, factors influencing changes, etc., which may improve understanding of ecosystems and/or infrastructure and may aid in making informed decisions regarding conservation, development, maintenance, and/or resource management.

### BRIEF DESCRIPTION OF THE DRAWINGS

The present systems and methods correspond to tracking of environmental features corresponding to sensor data obtained using a machine, wherein:

FIG. 1A illustrates an example environment of an analyzing module generating a tracking output corresponding to sensor data, in accordance with one or more embodiments of the present disclosure;

FIG. 1B illustrates an example environment for identifying an aspect of an environmental feature using one or more sensors of a machine and an analyzing module, in accordance with one or more embodiments of the present disclosure;

FIG. 2 illustrates a flowchart of an example method for tracking of environmental features based on the resource data of a machine, in accordance with one or more embodiments of the present disclosure;

FIG. 3 illustrates an example environment for an environmental monitoring system generating a tracking output, in accordance with one or more embodiments of the present disclosure;

FIG. 4 is a flow diagram showing a method for obtaining sensor data indicating an environmental feature using a machine, in accordance with one or more embodiments of the present disclosure;

FIG. 5A illustrates an example machine (e.g., an autonomous or semi-autonomous vehicle), in accordance with one or more embodiments of the present disclosure;

FIG. 5B is an example of sensor (e.g., camera) locations and fields of view for the example autonomous vehicle of FIG. 5A, in accordance with one or more embodiments of the present disclosure;

FIG. 5C is a block diagram of an example system architecture for the example autonomous vehicle of FIG. 5A, in accordance with one or more embodiments of the present disclosure;

FIG. 5D is a system diagram for communication between cloud-based server(s) and the example autonomous vehicle of FIG. 5A, in accordance with one or more embodiments of the present disclosure; and

FIG. 6 is a block diagram of an example computing device suitable for use in implementing one or more embodiments of the present disclosure.

### DETAILED DESCRIPTION

Systems, including systems and subsystems corresponding to a machine, may collect, generate, and/or otherwise obtain, process, use, analyze, transmit, etc. data corresponding to the environment of the systems or of other systems or subsystems during operation. In some instances, the systems may accept little to no user input, such as, for example, autonomous or semi-autonomous systems. Additionally or alternatively, the systems may accept user input for performance of control operations, such as, for example, manned vehicles. Further, in some instances, the systems may include systems and/or subsystems that may obtain data corresponding to performance of various control operations and/or to system resource availability. For example, some systems may obtain data corresponding to energy consumption, fuel consumption, speed, temperature, etc. of the systems. In some instances, a system may obtain data about the environment of the system as part of performing one or more control operations.

Environmental monitoring may involve the systematic examination of an environment to gather information concerning its current condition, changes over time, and/or factors influencing change. A machine may obtain, process, use, analyze, transmit, etc. sensor data related to the environment of the machine. For example, a machine may collect sensor data using one or more sensors as part of performing one or more control operations related to autonomous or semi-autonomous operation.

Additionally or alternatively, an artificial intelligence (AI) model (e.g., machine learning model, deep neural network (DNN), large language model (LLM), vision language model (VLM), and/or other model types) may be trained to perform environmental monitoring using the sensor data. For example, in some embodiments, the AI model may receive sensor data input, such as from a sensor, run an inference on the sensor data, and output a data structure, representation, and/or information regarding one or more environmental features.

By way of example, the running of the inference may include the process of inputting non-training sensor data (e.g., production data or real-world data) to the AI model, which may be trained to make a prediction, solve a task, output a calculation, etc. based on the inputted sensor data.

Additionally or alternatively, the AI model may receive sensor data input that may be used as training data to train the AI model. For example, a sensor may obtain sensor data corresponding to an environment over time (e.g., images of trees lining a street passed by regularly as part of a commute in the machine). The sensor data may be labeled to indicate different portions of the sensor data that corresponds to different elements of the environment. In these and other embodiments, the labeled sensor data may be used by an analyzing module configured to operate one or more AI models such that the AI models may be trained with the labeled sensor data to better identify environmental features in that environment and/or similar environments. Employing AI models in this manner to analyze data obtained by one or more sensors may reduce human error, increase speed of detection of and/or reporting of changes to environmental features, and/or increase scalability (e.g., monitoring larger geographic areas, monitoring multiple environmental features simultaneously, etc.).

For example, traditional approaches for environmental monitoring may be hindered by the remoteness of an environment. Additionally or alternatively, traditional approaches to environmental monitoring may include surveying performed by one or more humans, which may be labor intensive, time-consuming, limited in coverage, and/or susceptible to human bias/error. Thus, in some embodiments, the ability to monitor remote environments and/or to survey unique or formerly human-only monitored environmental features may be improved by using one or more machines such as an ego-machine. For example, a machine may be able to travel to remote environments such as deserts, tundra, deep sea regions, mountain peaks, etc. where infrastructure and/or human surveying is less practical and/or impractical.

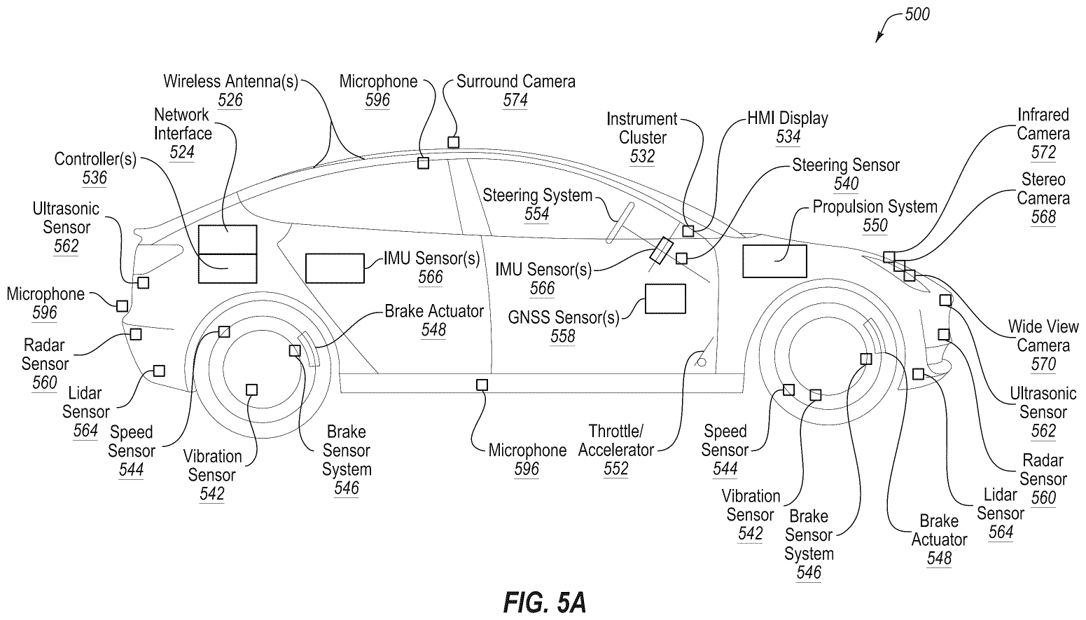

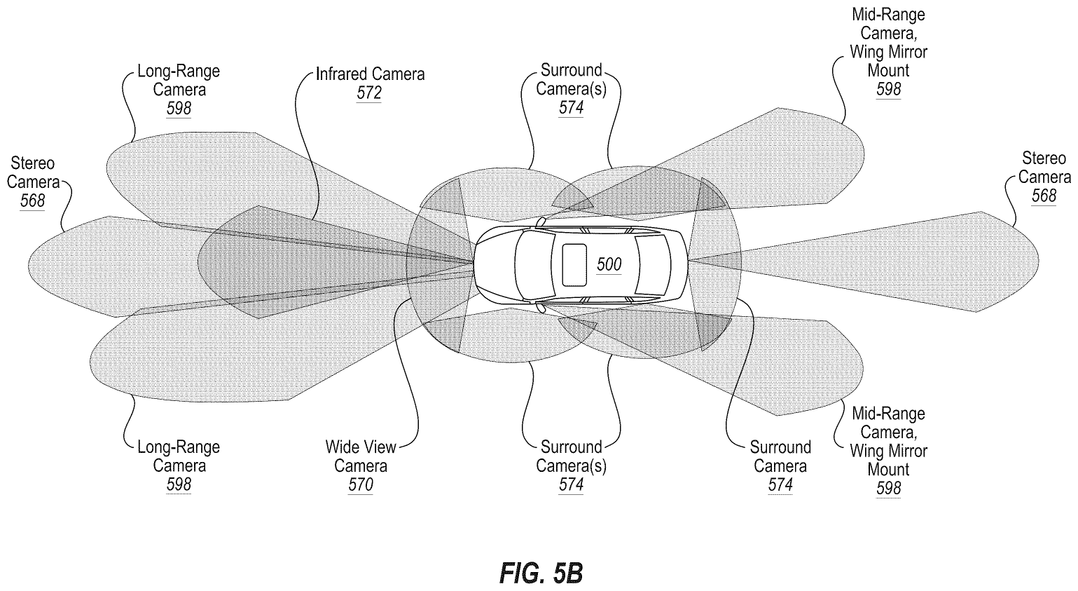

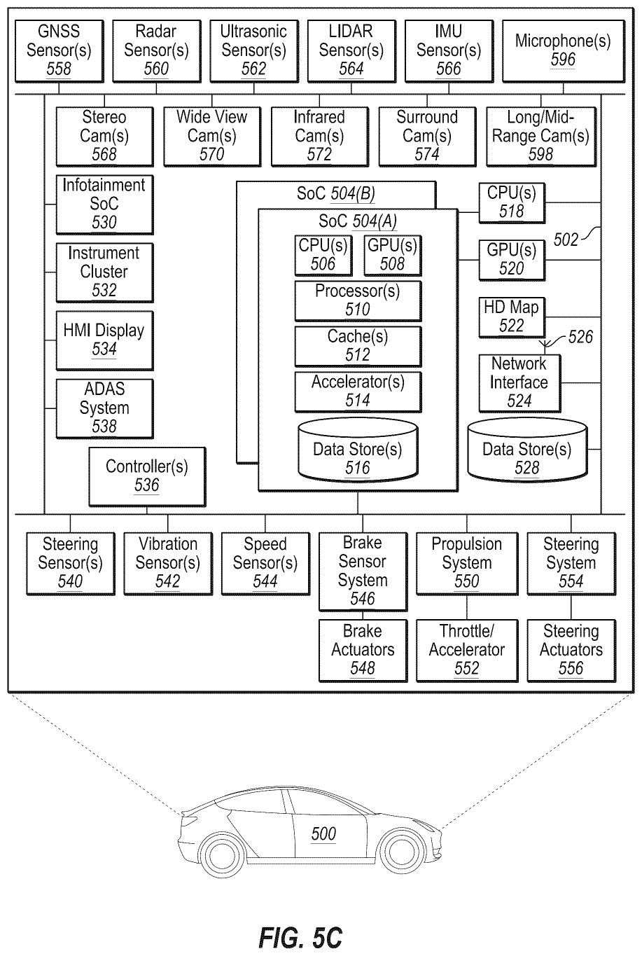

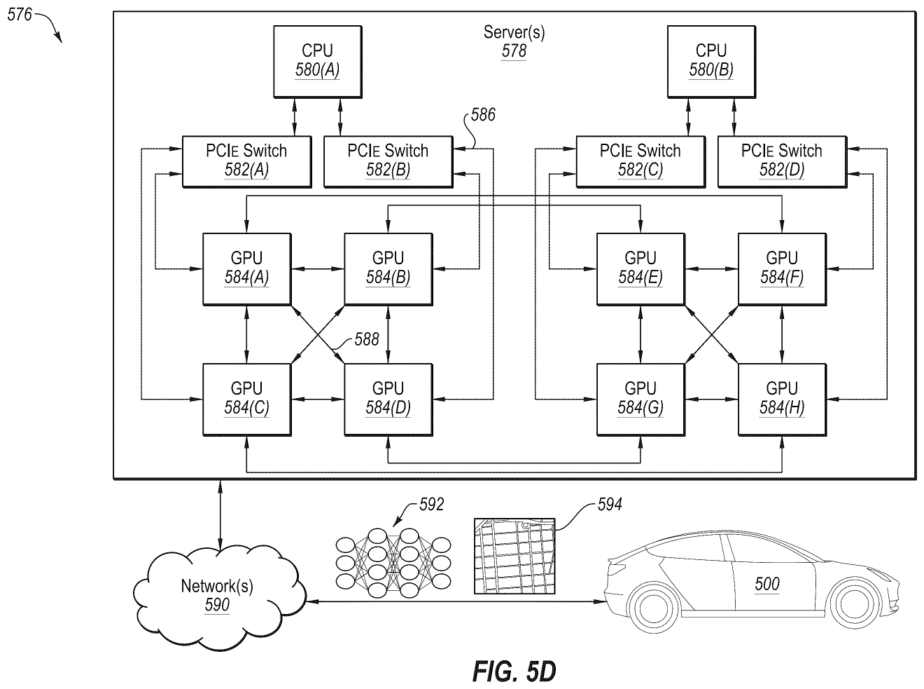

In some embodiments, the machine may include any applicable machine or system that is capable of performing one or more autonomous and/or semi-autonomous control operations. For instance, control operations may include route planning operations, navigation operations, perception operations, localization operations, actuation operations, communication operations, and/or any other operation or operations performed by the machine. In some embodiments, the control operations may relate to controlling travel-related tasks (e.g., control over the movement of the machine from one location to another such as via steering, accelerating, and/or braking). Additionally or alternatively, the control operations may relate to non-travel-related functionalities of the machine (e.g., control over fans to regulate the temperature of the machine, control over a robotic arm of the machine, control over volume level of alarms/alerts given by the machine, etc.). Example machines may include, but are not limited to, vehicles (land, sea, space, and/or air), robots, robotic platforms, etc. By way of example, the machine may include one or more computing applications executed by an autonomous vehicle or semi-autonomous vehicle, such as example autonomous or semi-autonomous vehicle or machine 500 (alternatively referred to herein as “vehicle 500” or “ego-machine 500”) described with respect to FIGS. 5A-5D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems, subsystems, and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats (e.g., autonomous boats or unmanned surface vessels (USVs), shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems for hosting real-time streaming applications, systems that implement one or more vision language models (VLMs), systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function, unless described otherwise.

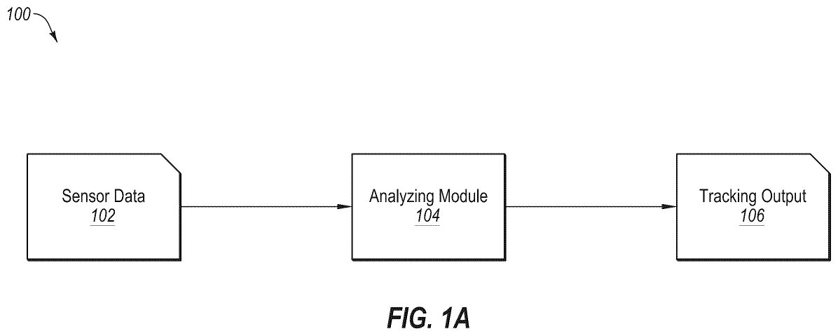

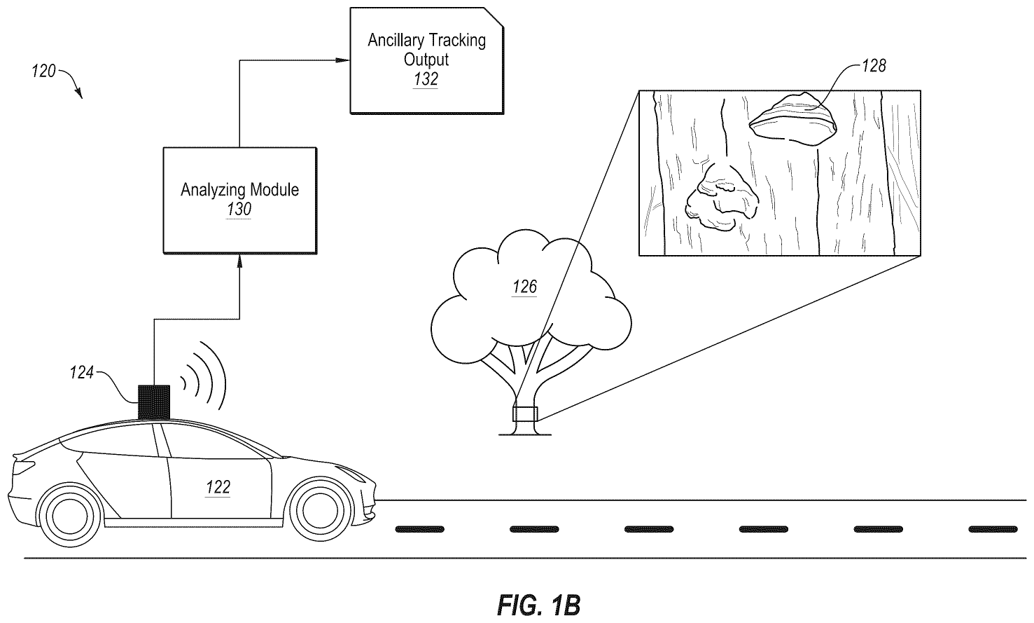

Now referring to the figures, FIG. 1A is a diagram representing an example system 100 for generating a tracking output 106, in accordance with one or more embodiments of the present disclosure. In some embodiments, the example system 100 may include an analyzing module 104 that may be configured to generate the tracking output 106 using sensor data 102. In some embodiments, the analyzing module 104 may be included in and/or associated with a machine (e.g., an ego-machine).

In some embodiments, the sensor data 102 may include any data that may be obtained using one or more sensors. For example, the sensor data 102 may include image data (e.g., captured images), GPS data, RADAR data, LiDAR data, temperature data, audio data, etc. In some embodiments, the sensor data 102 may be obtained using sensors such as, for example, one or more image sensors (e.g., cameras), RADAR sensors, LiDAR sensors, sound navigation and ranging (SONAR) sensors, infrared sensors, ultrasonic sensors, proximity sensors, and/or any other type of sensor that may generate and/or collect sensor data 102.

Additionally or alternatively, in some embodiments, the sensor data 102 may correspond to one or more sensors that may obtain (e.g., generate and/or collect) data corresponding to the environment in which the sensor may be located. For example, the sensor data 102 may be obtained using one or more temperature sensors, humidity sensors, barometric pressure sensors (e.g., barometers), rain gauges, UV sensors, radiation detectors, and/or other sensors that may generate data and/or information corresponding to the environment in which the machine may be located. For instance, a camera on a machine may capture images of vegetation (e.g., trees, shrubs, etc.), pests (e.g., locusts, wild hogs, etc.), bodies of water (lakes, ponds, rivers, streams, ocean, etc.), vandalism (e.g., broken objects, graffiti, etc.), large roadside items indicating illegal dumping (e.g., refrigerators, mattresses, etc.), street furniture (e.g., bus stops, trash cans, traffic poles, etc.), wildfires or other fires, hazards (e.g., oil slicks, algae blooms, etc.), traffic infrastructure (e.g., traffic signs, traffic lights, median walls and barriers, highway fences, pylons, streetlights, electronic traffic signs, road surface markings, lane markers, potholes, etc.), power infrastructure (e.g., power lines, utility pole, substations, etc.), the atmospheric/weather features (e.g., cloud patterns, precipitation, etc.), natural phenomenon (e.g., moon phases, aurora borealis, rainbows, meteor showers, stars, etc.), etc.

In these and other embodiments, the sensor data 102 may capture information regarding one or more environmental features that is not primarily related (e.g., ancillary) to the machine performing control operations. For example, an autonomous vehicle may primarily obtain sensor data 102 indicating that there is a tree along the side of a road to keep the autonomous vehicle from colliding with the tree as part of the autonomous vehicle's control operations. However, to continue the example, the sensor data 102 of the tree may also be analyzed by the analyzing module 104 to identify and/or track an ancillary aspect of the tree (e.g., changes in leaf color, existence of fungus/mold/disease, etc.). Thus, in some embodiments, a tracking output 106 may be generated by the analyzing module 104 based on the sensor data 102 in which the tracking output 106 generation or use may have an ancillary relationship to control operations that may be performed by the machine.

In some embodiments, the tracking output 106 may correspond to obtaining, identifying, and/or tracking environmental features such as pollution, light, graffiti, litter, plants, wildlife, bodies of water, fires, atmospheric conditions including cloud patterns and movement, people including facial features of people, vehicles including makes/models and license plate numbers, etc. For example, the tracking output 106 may include and/or correspond to a state of at least one of pollution, light, graffiti, litter, plants, wildlife, bodies of water, fires, atmospheric conditions, people, or vehicles.

For example, the sensor data 102 may be image data indicating a large item such as a couch was dumped on the side of a road, which in turn may correspond to the tracking output 106 from the analyzing module 104 representing collision risk, fire hazard risk, etc. posed by the large item. In some embodiments, the tracking output 106 may be reported to one or more third parties. For example, continuing the scenario above where a large item dumped on the side of the road has been indicated in the tracking output 106, the third parties to which the tracking output 106 may be reported may include local authorities and/or road maintenance work for timely removal. As another example, the sensor data 102 may include image data about a traffic sign and may correspond to the tracking output 106 indicating the traffic sign contains graffiti, which may have detrimental effects on the readability/interpretability the traffic sign. In some embodiments, environmental monitoring may reveal patterns, such as specific locations more prone to damage and/or vandalism, thereby allowing for targeted interventions.

In these and other embodiments, the sensor data 102 may include data and/or information that may be generated using one or more sensors that may be configured to measure one or more movement characteristics. For example, the sensor data 102 may include data and/or information generated using one or more speed sensors, accelerometers, gyroscopes, inertial measurement units (IMUs), Global Positioning System (GPS) sensors, strain gauges, tilt sensors (e.g., inclinometers), and/or other sensors that may be used to generate and/or collect data corresponding to one or more movement characteristics of one or more machines, systems, devices, etc.

In some embodiments, the sensor data 102 may include metadata. In some embodiments, the metadata may indicate the structure of the sensor data 102, the sensor and/or channel to which the sensor data 102 may correspond, one or more timestamps for when the sensor data may have been obtained, data and/or information corresponding to one or more intrinsic characteristics of the sensor from which the sensor data 102 may have been obtained (e.g., focal length, sensitivity, accuracy, resolution, calibration requirements, operating range, etc.).

In some embodiments, one or more of the sensors used to obtain the sensor data 102 may correspond to the machine. For example, the sensors may be disposed on (e.g., physically coupled to) the machine. Additionally or alternatively, one or more of the sensors may be communicatively coupled to the machine. In these and other embodiments, the sensor data 102 may be obtained using one or more sensors that may be described and/or illustrated in the present disclosure, such as, for example, with respect to the sensor 124 in FIG. 1B.

In some embodiments, the sensor data 102 may be obtained by the analyzing module 104. For example, the analyzing module 104 may include an input unit for receiving an input of sensor data 102, a memory for storing the sensor data 102, and a processor for controlling the input unit and the memory. In these and other embodiments, the processor may receive an input of sensor data 10, execute instructions to train an AI model, and/or execute instructions to generate a tracking output. Additionally or alternatively, the processor may execute instructions to communicate the tracking output to the analyzing module 104, to a remote server, to a sensor, to the machine, to additional machines, and/or to a third party. In some embodiments, the sensor data 102 may be received, processed, used, analyzed, and/or transmitted by the analyzing module 104 receiving such sensor data 102 from one or more other suitable devices that are configured to obtain sensor data 102 and that are communicatively coupled to the analyzing module 104.

In some embodiments, the analyzing module 104 may include code and routines configured to allow a computing system to perform one or more control operations. Additionally or alternatively, the analyzing module 104 may be implemented using hardware including one or more processors, CPUs graphics processing units (GPUS), data processing units (DPUs), parallel processing units (PPUs), microprocessors (e.g., to perform or control performance of one or more operations), field-programmable gate arrays (FPGAs), application-specific integrated circuits (ASICs), accelerators (e.g., deep learning accelerators (DLAs)), and/or other processor types. In these and other embodiments, the analyzing module 104 may be implemented using a combination of hardware and software. In the present disclosure, control operations described as being performed by the analyzing module 104 may include operations that the analyzing module 104 may direct a corresponding computing system to perform. In these or other embodiments, the analyzing module 104 may be implemented by one or more computing devices, such as that described in further detail with respect to FIGS. 5A-5D and/or 6.

In some embodiments, the analyzing module 104 may include one or more AI models configured to evaluate data and make predictions and/or calculations. For example, the analyzing module 104 may be configured to operate one or more AI models such as perception models (e.g., PointNet, You Only Look Once (YOLO)), etc.), Simultaneous Localization and Mapping (SLAM) models (e.g., FastSLAM, GraphSLAM, ORB-SLAM, etc.), path planning models (e.g., A*, rapidly exploring random tree (RRT), etc.), deep learning models (e.g., convolutional neural networks (CNNs), recurrent neural networks (RNNs), etc.), and/or any other applicable AI model (e.g., large language models (LLMs), vision language models (VLMs), etc.).

In these and other embodiments, the analyzing module 104 may receive an input of the sensor data 102, apply one or more of AI models, and generate the tracking output 106. For example, the analyzing module 104 may receive sensor data 102 corresponding to trees in the environment such that the analyzing module 104 may generate a tracking output 106 that identifies the species of the trees; detects anomalies in tree leaves, bark, and/or overall structure; differentiates between healthy and diseased/stressed trees; etc. For instance, the analyzing module 104 may recognize early signs of fungal, bacterial, and/or viral infections; identify pest-induced damage (e.g., boreholes, webbings, chewed leaves, etc.); predict potential disease outbreaks by analyzing patterns and/or spread; correlate tree health with historical environmental data to identify potential causes of stress; etc. In some embodiments, the analyzing module 104 may have real-time or near real-time analysis capabilities which may allow for detected environmental features to be timely reported to local authorities such as forest managers. In these and other embodiments, real-time or near real-time analysis by the analyzing module 104 may increase the efficiency of resource deployments to affected areas, proper identification of useful preventative measures and/or treatments, and/or improved monitoring of post-intervention recovery progress.

Modifications, additions, or omissions may be made to FIG. 1A without departing from the scope of the present disclosure. For example, the types of sensor data 102 and/or analyzing module 104 may vary. The specifics given and discussed are to help provide explanation and understanding of concepts of the present disclosure and are not meant to be limiting.

FIG. 1B illustrates an example environment 120 for generating an ancillary tracking output 132 corresponding to an environmental feature 126 based on sensor data, in accordance with one or more embodiments of the present disclosure. For example, an analyzing module 130 may generate the ancillary tracking output 132 and the sensor data may be obtained from sensors 124 (e.g., one or more sensors 124 that are part of a machine 122).

In some embodiments, the environment 120 may include an example implementation of the system 100 of FIG. 1A. For example, the sensors 124 may generate the sensor data 102. In some embodiments, the analyzing module 130 may be included in and/or associated with the machine 122 that may be located in the environment 120, where the analyzing module 130 may be the same as and/or analogous to the analyzing module 104.

In some embodiments, the example environment 120 may include a physical area in which the machine 122 may be located—although a virtual or simulated environment may be used for testing/validation purposes, in embodiments. In some embodiments, the one or more sensors 124 may correspond to the machine 122 (e.g., the sensors 124 may be located or disposed on or in the machine 122) and may generate sensor data corresponding to an environmental feature 126.

The machine 122 may include one or more machines that may be configured to receive or otherwise obtain, process, use, analyze, and/or transmit sensor data corresponding to one or more sensors 124. In some embodiments, the machine 122 may include one or more machines that may navigate a particular environment based at least on sensor data corresponding to one or more sensors 124. In some embodiments, the machine 122 may include any applicable machine or system that is capable of performing one or more autonomous or semi-autonomous control operations. For example, the machine 122 may include an autonomous vehicle or semi-autonomous vehicle, such as an example autonomous or semi-autonomous machine or vehicle 500 (alternatively referred to herein as “vehicle 500” or “ego-machine 500”) described with respect to FIGS. 5A-5D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

In some embodiments, the machine 122 may include one or more systems, sub-systems, machine learning models, neural networks, deep neural networks, etc. that may be configured to determine one or more perception, planning, control, safety, and/or other autonomous or semi-autonomous control operations based on data that may be received and/or otherwise obtained. For example, sensor data corresponding to one or more of the sensors 124 may be received by or otherwise communicated to the machine 122. The machine 122 may be configured to determine one or more control operations to perform based at least on the sensor data generated using the one or more corresponding sensors 124.

For example, the one or more autonomous or semi-autonomous control operations may include altering one or more paths through the environment, decelerating, accelerating, turning, changing lanes, performing one or more evasive maneuvers, coming to a stop, handing control back to a human operator, etc. Aside from physical movement, the machine 122 may perform one or more internal control operations based on sensor data, such as, for example, increasing power to one or more internal heating elements in response to cold temperatures or, conversely, increasing power to one or more cooling elements (e.g., fans and the like) in response to warm temperatures, where the temperature may be determined using sensor data collected and/or generated using one or more sensors corresponding to the machine 122. In some embodiments, the machine 122 may include the sensors 124 associated therewith or corresponding thereto. For example, the sensors 124 may be disposed on the machine 122.

The sensors 124 may respectively correspond to a particular sensor modality. A sensor modality may include a particular category of sensors that may be used to detect and measure one or more characteristics of the environment 120. In some embodiments, different sensor modalities may refer to differences in sensor data corresponding to the sensors 124. For example, a first sensor modality may include sensors that may generate image data, a second sensor modality may include sensors that may generate RADAR data, a third sensor modality may include sensors that may generate LiDAR data, and so on. In some embodiments two or more of the sensors 124 may correspond to a same sensor modality. Additionally or alternatively, two or more of the sensors 104 may correspond to different sensor modalities. For example, a first sensor may be an image sensor, a second sensor may be a RADAR sensor, and a third sensor may be a LiDAR sensor.

In some embodiments, the sensors 124 may be configured to generate and/or collect sensor data corresponding to the environment 120. For example, in the context of the sensors 124 as image sensors, the image sensors may be configured to generate image data corresponding to the environment. The image data, in the example, may be used by the machine 122 to perceive one or more characteristics, objects, obstacles, and/or other portions of the environment 120 in which the machine 122 may be located. In some embodiments, the sensors 124 may be configured to generate sensor data corresponding to respective fields of view (or sensory fields) of the sensors 124.

In some embodiments, the one or more sensors 124 may generate and/or collect sensor data representative of the environmental feature 126 (e.g., a feature of the environment of the machine 122). In some embodiments, the environmental feature 126 may include one or more objects within the environment 120. For example, the environmental feature 126 may include one or more static and/or dynamic objects such as streetlights, traffic medians, barriers, road hazards, traffic signs, other signs (e.g., building/office signs), traffic signals, construction barricades, street furniture (e.g., bus stops, trash cans, etc.), litter, roadside debris, powerlines, vegetation, animals, etc. within the environment 120. For example, in the context of the machine 122 as a vehicle, the environmental feature 126 may include one or more other vehicles. Additionally or alternatively, the environmental feature 126 may include and/or represent one or more of weather patterns, light pollution, etc. In some embodiments, the environmental feature 126 may be detected using sensor data corresponding to one or more sensors 124.

In some embodiments, the machine 122 may be configured to obtain, process, use, analyze, transmit, etc. sensor data corresponding to or using a specific sensor 124 based on the analyzing module 130 identifying that specific sensor 124 as being able to capture sensor data with the highest confidence of detection of the sensors 124 available on the machine 122. For example, to capture data on cloud patterns, the analyzing module 130 may identify that an upwards facing image sensor on top of the machine is most likely to capture useful sensor data for detecting cloud patterns. Additionally or alternatively, the machine computing system may obtain sensor data from multiple sensors 124 simultaneously. In these and other embodiments, the analyzing module 130 may, in response to receiving multiple different sensor data captures of an environmental feature, train itself to better identify which sensors 124 are optimal for obtaining sensor data of certain environmental features.

In some embodiments, sensor data corresponding to the environmental feature 126 may be communicated to the analyzing module 130. For example, the sensor 124 may send the sensor data to the analyzing module 130. Additionally or alternatively, the machine 122 and/or the computing system of the machine 122 may send the sensor data to the analyzing module 130. In some embodiments, the analyzing module 130 may be integrated with the machine 122 and/or the computing system of the machine 122. In some embodiments, the analyzing module 130 may be located and/or accessed at a remote computing system or device that is separate and/or remote from the machine 122. For example, in some embodiments, one or more remote servers may improve obtaining the sensor data and/or sending the sensor data to the analyzing module 130 by facilitating the aggregation of sensor data from a network of machines to a single remote server for data processing. One or more control operations that accumulate the data related to a specific environmental feature 126 for data processing by an analyzing module 130 may improve the efficiency and accuracy of predictions made by the analyzing module 130.

In some embodiments, the ancillary tracking output 132 may represent an aspect 128 of an environmental feature 126 as identified by the analyzing module 130 using the sensor data obtained by the sensor 124 on the machine 122. For example, as illustrated, the sensor 124 may obtain data corresponding to an environmental feature 126 that is a tree. The machine 122 may perform one or more autonomous or semi-autonomous control operations as a result of the sensor 124 and/or the analyzing module 130 identifying the existence of the tree such as maneuvering around the tree, adjusting vehicle speed, etc. In some embodiments, the analyzing module 130 may also identify in the sensor data obtained by the sensor 124 is that the environmental feature 126 includes an aspect 128 ancillary (e.g., supplemental) to the machine 122 performing the control operations. For example, while the existence of an aspect 128 such as fungus on an environmental feature 126 may be ancillary to the machine 122 functioning as generally intended (e.g., driving normally), information concerning the fungus on the tree may be of interest to an arborist.

Modifications, additions, or omissions may be made to FIG. 1B without departing from the scope of the present disclosure. For example, the number of machines 122, the number of sensors 124, the number of environmental features 126, and/or the number of aspects 128 of an environmental feature 126 may vary. The size, type, etc. of the environmental feature 126 may vary. The specifics given and discussed are to help provide explanation and understanding of concepts of the present disclosure and are not meant to be limiting.

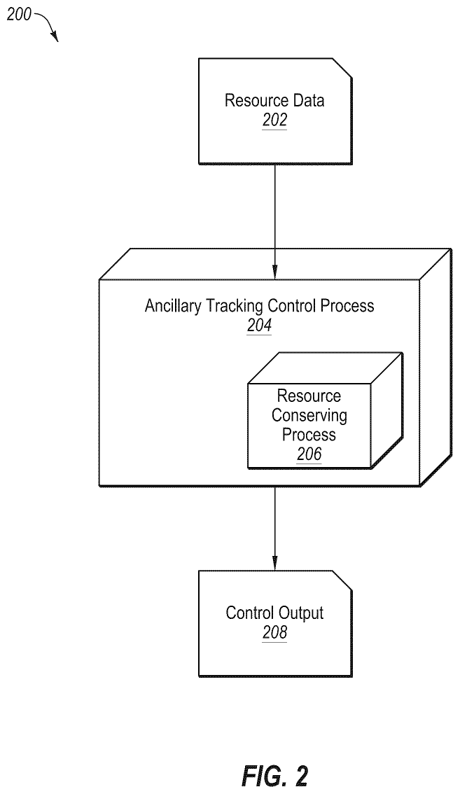

FIG. 2 illustrates an example process 200 configured to determine a control output 208 based on resource data 202, in accordance with one or more embodiments of the present disclosure. In some embodiments, the process 200 may be performed with respect to a machine (e.g., ego-machine) to determine which operations to perform at certain times with respect to ancillary tracking described in the present disclosure (e.g., such as described with respect to FIGS. 1A and 1B). In some embodiments, one or more operations of the process 200 may be performed at the machine (e.g., by a computing device of the machine). Additionally or alternatively, one or more operations may be performed remote from the machine. In some embodiments, the process 200 may include an ancillary tracking control process 204, which may include a resource conserving process 206.

In some embodiments, obtaining, generating, processing, using, analyzing, transmitting, etc. sensor data and/or an ancillary tracking output may consume finite resources of the machine. The resources may be used by the machine to perform operations and may be subject to constraints in terms of availability and/or capacity. In some embodiments, the resource data 202 may include information about the resources. For example, the resource data 202 may include data about the computing resources of the machine. For instance, the machine may have computing memory to store instructions and/or data for access. In some embodiments, ancillary tracking may use up available computing memory such as when ancillary tracking operations involve instructions stored in the machine's memory. As another example, the resource data 202 may include data about network speed, the resource that may determine how quickly data may be transmitted from one point to another (e.g., from sensors on the machine to the computing system of the machine, from the machine to a remote server, etc.). In some embodiments, generating an ancillary tracking output may impact network speed as increased data transmission may saturate network bandwidth thereby reducing the effective network speed. In some embodiments, the resource data 202 may include data about network availability. For example, machines such as autonomous vehicles may operate in environments with limited network availability such as urban areas or remote locations. In some embodiments, accessing the network with limited network availability may be impacted by the machine performing additional operations such as ancillary tracking as more operations may increase demand for network bandwidth, increase network congestion, increase resource contention, etc. In some embodiments, the resource data 202 may indicate that ancillary tracking operations may compete with operations of the machine (e.g., operations for transmitting safety-related data, operations for receiving updates from navigation servers) over shared resources. For example, ancillary tracking operations and operations related to autonomous or semi-autonomous travel may compete over random-access memory (RAM), disk storage, cache memory, internal buses, external network devices, etc.

In some embodiments, the resource data 202 may include information about power resources of the machine. For example, the machine may have batteries, fuel cells, an engine, solar panels, auxiliary power units (APUs), etc. that consume power as electricity and/or fuel. In some embodiments, ancillary tracking may impact electricity and/or fuel resources of the machine as sensors used to obtain sensor data and/or send obtained sensor data to an analyzing module. In these and other embodiments, the resource data 202 may inform the decision-making process within a machine's operational framework. For example, based on the resource data 202, the machine may decide to allocate power to run a fan, air conditioning unit, and/or cooling unit of the machine in response to the machine experiencing temperatures above a certain threshold instead of allocating the power to ancillary tracking of an environmental feature such as cloud patterns.

In some embodiments, the ancillary tracking control process 204 may include obtaining the resource data 202 to determine a control output 208. For example, obtaining the resource data 202 may include the ancillary tracking control process 204 being configured to receive inputs indicating the availability and/or capacity of one or more resources of the machine. For instance, the ancillary tracking control process 204 may be configured to receive inputs from sensors in an engine control unit (ECU) (e.g., Mass Airflow (MAF) sensor, engine coolant temperature sensor, crankshaft position sensor, etc.), a transmission control unit (TCU) (e.g., transmission fluid temperature sensor, transmission speed sensor, etc.), a brake system (e.g., wheel speed sensor, brake fluid level sensor, etc.), a tire pressure monitoring system (TPMS) (e.g., tire pressure sensor), a fuel system (e.g., fuel level sensor), etc.

Additionally or alternatively, the ancillary tracking control process 204 may receive inputs indicating information external to the machine such as weather conditions, road conditions, traffic conditions, etc. In some embodiments, the ancillary tracking control process 204 may determine the control output 208 based on both the resource data 202 and on the external information. For example, the ancillary tracking control process 204 may determine the control output 208 based on both the current amount of gasoline in the machine's fuel tank and on information indicating that upcoming mountainous terrain makes for poor gas mileage.

In some embodiments, the ancillary tracking control process 204 may include determining the state of the current resource data or allocation and/or what the resource data is predicted to be over time. For example, the ancillary tracking control process 204 may include comparing the resource data 202 to one or more thresholds. For instance, the resource data 202 may correspond to the battery life remaining such that the ancillary tracking control process 204 may include determining that the resource data 202 satisfies a threshold if the battery life remaining is at least 10%, at least 25%, at least 50%, and/or any other predetermined percentage. As another example, the ancillary tracking control process 204 may be based on resource data 202 indicating the machine currently has no available computing memory and that there is no network availability to upload data stored on the computing memory to free up additional space. To continue the example, in such a scenario, the ancillary tracking control process 204 may determine that the resources are currently unavailable, may predict that the resources are unlikely to be available until the machine reaches its destination, and/or that the machine may continue to safely perform control operations to the machine's destination by limiting or eliminating ancillary tracking operations.

In some embodiments, the ancillary tracking control process 204 may determine when sensor data for ancillary tracking is obtained. For example, the ancillary tracking control process 204 may determine based on the resource data 202 that the machine has resources to obtain sensor data of environmental features. Additionally or alternatively, the ancillary tracking control process 204 may determine when the obtained sensor data may be sent to an analyzing module. For example, the ancillary tracking control process 204 may determine that the machine may send sensor data to an analyzing module that is included in the machine even when resources are relatively low. In some embodiments, the ancillary tracking control process 204 may determine that the machine may send sensor data to an analyzing module that is included in a remote server by weighing factors including the resource data 202 and the distance between the machine and the remote server.

In some embodiments, the ancillary tracking control process 204 may determine where sensor data is sent. For example, in response to a certain analyzing module included on a remote server prompting machines to send in data related to an automobile accident in a nearby town, the ancillary tracking control process 204 may determine that the machine near the remote server but without any data related to the automobile accident would waste resources uploading sensor data at that time to that analyzing module.

In some embodiments, the ancillary tracking control process 204 may determine when (e.g., under what conditions) certain types of data is sent to a remote server. For example, sometimes there may be enough resources to send low-resolution data to a remote server, but not high-resolution data. In some embodiments, an analyzing module may request higher-resolution data after having received low-resolution data, which the ancillary tracking control process 204 may authorize. In some embodiments, the ancillary tracking control process 204 may determine the machine may benefit from obtaining sensor data but holding off on sending the sensor data to an analyzing module until the machine is located in an area with sufficient resources. For example, the ancillary tracking control process may be configured to permit the machine to upload sensor data to an analyzing module while the machine is charging or otherwise replenishing resources.

In some embodiments, the ancillary tracking control process 204 may be controlled by a user. For example, the user may elect for personal reasons to not grant permission for ancillary tracking of graffiti (e.g., the user enjoys the graffiti, the user feels it would be a waste of her vehicle's resources to constantly be detecting graffiti, etc.) while still permitting ancillary tracking of other environmental features such as potholes.

In some embodiments, the ancillary tracking control process 204 may determine based on the resource data 202 that the machine has enough resources to perform ancillary tracking for a certain time frame, distance, and/or any other desired metric. For example, based on resource data 202 indicating a fully charged electric vehicle, the ancillary tracking control process 204 may determine the machine is capable of performing ancillary tracking for multiple hours, for hundreds of miles of travel, for as long as the machine has memory available, etc.

In some embodiments, the ancillary tracking control process 204 may include one or more subprocesses such as a resource conserving process 206. For example, in response to the machine having limited resources available, the resource conserving process 206 may include performing calculations to determine how long the machine can continue to perform control operations while further performing ancillary tracking. Additionally or alternatively, the resource conserving process 206 may indicate to the ancillary tracking control process 204 that one or more resources have fallen below or are predicted to fall below a threshold such that certain resources may not be used for ancillary tracking. For instance, a machine may have a destination 50 miles away such that the resource conserving process 206 may indicate that the machine has enough power to reach the destination so long as the machine does not allocate more than a certain amount of the resources to performing ancillary tracking.

In some embodiments, the control output 208 may indicate which resources of the machine may be allocated to performing certain control operations. In some embodiments, the ancillary tracking control process 204 may generate a control output 208 instructing a reduction or stopping of, processing, using, analyzing, transmitting, etc. sensor data corresponding to ancillary tracking in response to the ancillary tracking control process 204 determining that at least a portion of the resource data 202 is below a threshold. Additionally or alternatively, the ancillary tracking control process 204 may generate a control output 208 instructing the continual collection of sensor data for ancillary tracking but not to upload the sensor data to a remote server at that time based on the resource data 202. In some embodiments, the ancillary tracking control process 204 may generate the control output 208 by performing an optimization calculation.

In some embodiments, the control output 208 may include instructions to one or more components (e.g., sensors, computing system, etc.) of the machine to start or stop performing ancillary tracking operations based on the resource data 202. For example, the machine may receive a prompt to obtain sensor data related to migrating birds such that the control output 208 may be a line of code when executed by the machine causes the sensors on the machine to start obtaining sensor data (e.g., a camera pointed at the sky may start capturing images when motion is detected). Alternatively in such an example, in response to the ancillary tracking control process 204 determining that the machine does not have sufficient resources to perform operations related to its primary control operations as well as related to tracking migrating birds, the control output 208 may be a line of code when executed by the machine causes the components of the machine (e.g., an analyzing module such as described with respect to FIGS. 1A and 1B) to enter a low power/sleep mode with respect to such tracking.

In some embodiments, the ancillary tracking control process 204 and/or the resource conserving process 206 may be performed by the machine, by a computing system communicatively coupled to the machine, by an analyzing module, and/or combinations thereof.

In some embodiments, the control output 208 of the ancillary tracking control process 204 and/or the resource conserving process 206 may be adjusted based on one or more priority tasks identified by a priority system. For instance, an analyzing module may include a priority system such that certain tasks may be prioritized during certain conditions. For example, the priority system may prompt the machine to prioritize obtaining sensor data of vehicle colors, license plate numbers, makes and models, etc. and/or the processing of such data using AI in response to an outstanding AMBER Alert. In some embodiments, the priority system may be based on the priorities of the user of the machine (e.g., user may prioritize electricity of vehicle going to power stereo sound system over obtaining sensor data of invasive plant species) or may be based on priorities of a third party (e.g., local fire department may send prompt to prioritize obtaining sensor data of a building on fire).

Modifications, additions, or omissions may be made to FIG. 2 without departing from the scope of the present disclosure. For example, in some embodiments, the process 200 may include any number of other components that may not be explicitly illustrated or described. The specifics given and discussed are to help provide explanation and understanding of concepts of the present disclosure and are not meant to be limiting.

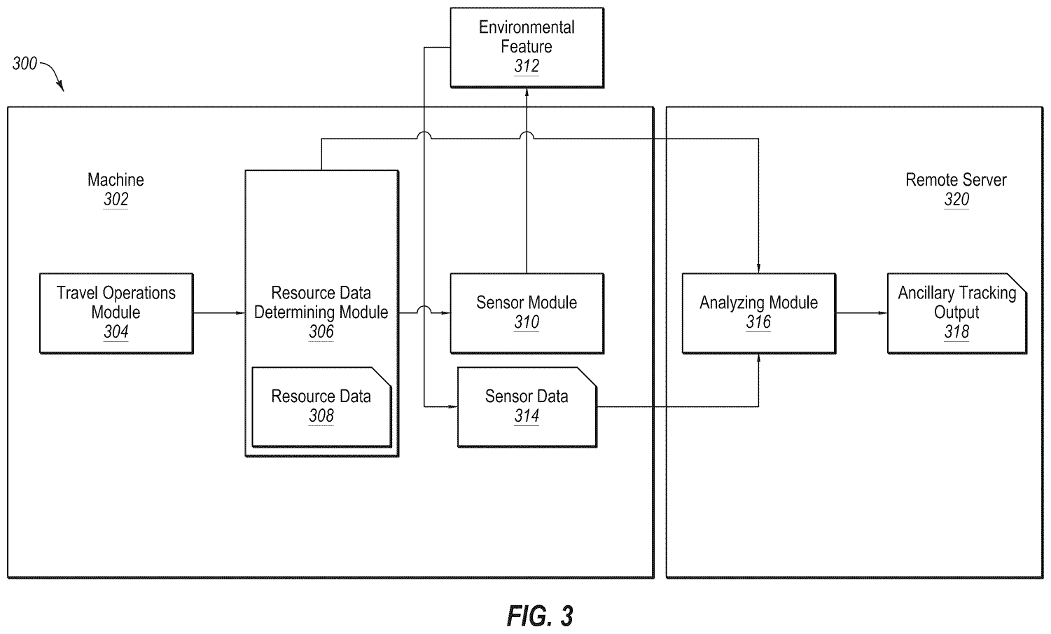

FIG. 3 illustrates an example environmental monitoring system 300 (“system 300”) related to generating one or more ancillary tracking outputs 318 of an environmental feature 312 using a machine 302 and a remote server 320, in accordance with one or more embodiments of the present disclosure. In some embodiments, the system 300 may be implemented in any suitable environment, such as the environment 120 that may be described and/or illustrated further in the present disclosure, such as, for example, with respect to FIG. 1B. In some embodiments, the system 300 may be configured to determine which operations to perform at certain times with respect to generating an ancillary tracking output 318 corresponding to an environmental feature 312 as described in the present disclosure. In some embodiments, the system 300 may include a control operations module 304, a resource data determining module 306, a sensor module 310, and/or an analyzing module 316.

In some embodiments, the machine 302 may be the same as and/or analogous to the machine 122 that may be described and/or illustrated further in the present disclosure, such as, for example, with respect to FIG. 1B. Additionally or alternatively, the machine 302 may be an example of any machine that may perform one or more control operations using one or more sensors such as those described and/or illustrated further in the present disclosure, such as, for example, with respect to the sensor 124 of FIG. 1B.

In some embodiments, the control operations module 304 may include hardware, software, and/or some combination thereof configured to operate the machine 302 in performing route planning and navigation tasks, sensor perception tasks, control and actuation tasks (e.g., steering, braking, accelerating, etc.), communication tasks, safety and emergency protocol tasks, user interface tasks, and/or other tasks generally related to the machine 302. For example, an autonomous vehicle may be an example machine 302 wherein the control operations module 304 may be configured to perform autonomous or semi-autonomous driving operations.

In some embodiments, the resource data determining module 306 may include hardware, software, and/or some combination thereof configured to obtain resource data 308. For example, the resource data determining module 306 may include one or more processors configured to execute instructions to perform an ancillary tracking control process, such as that described as ancillary tracking control process 204 with respect to FIG. 2, and/or to generate a control output, such as that described as control output 208 with respect to FIG. 2.

In some embodiments, the resource data 308 may be the same as and/or analogous to the resource data 202 that may be described and/or illustrated further in the present disclosure, such as, for example, with respect to FIG. 2.

In some embodiments, the sensor module 310 may include one or more sensors that may be described and/or illustrated in the present disclosure, such as, for example, with respect to the sensor 124 in FIG. 1B.

In some embodiments, the environmental feature 312 may be the same as and/or analogous to the environmental feature 126 that may be described and/or illustrated further in the present disclosure, such as, for example, with respect to FIG. 1B.

In some embodiments, the sensor data 314 may be the same as and/or analogous to the sensor data 102 that may be described and/or illustrated further in the present disclosure, such as, for example, with respect to FIG. 1A. Additionally or alternatively, the sensor data 314 may be an example of sensor data that may have been generated using one or more sensors (e.g., the sensor 124) that may be described and/or illustrated further in the present disclosure, such as, for example, with respect to FIG. 1B.

In some embodiments, the analyzing module 316 may be the same as and/or analogous to the analyzing module 104 that may be described and/or illustrated further in the present disclosure, such as, for example, with respect to FIG. 1A and/or the analyzing module 130 that may be described and/or illustrated further in the present disclosure, such as, for example, with respect to FIG. 1B. In some embodiments, the analyzing module 316 may be configured to operate one or more systems, subsystems, machine learning (ML) models, neural networks, large language models (LLMs), deep neural networks (DNNs), convolutional neural networks (CNNs), and/or other algorithms that may be configured to monitor one or more environmental features using the sensor data 314. For example, the analyzing module 316 may include one or more artificial intelligence (AI) models configured to process sensor data 314 and/or generate one or more ancillary tracking outputs 318. In some embodiments, the AI model may include any type of machine learning model, such as a ML model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoders, convolutional, recurrent, perceptron, long/short term memory/LSTM, Hopfield, Boltzmann, deep belief, deconvolutional, generative adversarial, liquid state machine, transformer, conformer, LLM, etc.), computer vision algorithms, and/or other types of ML models.

In some embodiments, the control operations module 304, resource data determining module 306, sensor module 310, and/or the analyzing module (together “the modules”) may be included in a portion of the machine 302. Additionally or alternatively, the modules may operate independently and/or in conjunction with the machine 302. For example, as shown, the analyzing module 316 may be remote of the machine 302 and rather located as a portion of a remote server 320. In some embodiments, the analyzing module 316 may be fully or partially located in/on the machine 302. Additionally or alternatively, the analyzing module 216 may be fully or partially located in a location separate from both the machine 302 and the remote server 320.

In some embodiments, the modules may include code and routines configured to allow a computing system to perform or control one or more operations. Additionally or alternatively, one or more of the modules may be implemented using hardware including one or more processors, CPUs, GPUs, DPUs, PPUs, microprocessors (e.g., to perform or control performance of one or more operations), FPGAs, ASICs, accelerators (e.g., DLAs), and/or other processor types. In these and other embodiments, the modules may be implemented using a combination of hardware and software. In the present disclosure, control operations described as being performed by the modules may include operations that the modules may direct a corresponding computing system to perform. In these or other embodiments, the modules may be implemented by one or more computing devices, such as that described in further detail with respect to FIGS. 5A-5D and/or 6.

In some embodiments, the ancillary tracking output 318 may be the same as and/or analogous to the ancillary tracking output 106 that may be described and/or illustrated further in the present disclosure, such as, for example, with respect to FIG. 1A and/or the ancillary tracking output 132 that may be described and/or illustrated further in the present disclosure, such as, for example, with respect to FIG. 1B. In some embodiments, the machine 302 may be configured to use the ancillary tracking output 318 to inform one or more operations of the machine 302. For example, the ancillary tracking output 318 may indicate that there is a relatively large amount of pollen in the air outside of a car such that in response, the car may be configured to automatically operate windshield wipers to improve visibility for the driver of the car, recirculate the air inside of the cabin instead of allowing outside air to enter inside of the cabin, etc.

In some embodiments, the remote server 320 may include a server that while remote and/or independent from the machine 302 may be located relatively close to the machine 302 such as at the edge of a network infrastructure. For example, the remote server 320 may be strategically positioned at or near roads, ports, runways or airstrips, gas stations, electric vehicle charging stations, etc. such that the remote server 320 may be likely to be relatively close to the machine 302. In some embodiments, the remote server 320 may be positioned to reduce latency and improve the performance of the machine 302 and/or of the computing system of the machine 302. For example, the remote server 320 may reduce the use of onboard resources of the machine 302 to analyze the sensor data 314 by including the analyzing module 316 at the remote server 320. In some embodiments, the remote server 320 may be within a particular radius of the machine 302 (e.g., 5 miles, 10 miles, 20 miles, etc.). In some embodiments, the remote server 320 and the machine 302 may communicate such that the machine 302 may perform control operations while at least a portion of environmental monitoring is performed by the remote server 320 (e.g., analyzing the sensor data 314 to generate the ancillary tracking output 318 may be done by the remote server 320 independently of the machine 302). For example, the machine 302 may communicate with the remote server 320, and/or vice versa, over a wireless network (e.g., LTE, Bluetooth, Wi-Fi, etc.). In some embodiments, communication between the machine 302 and the remote server 320 may use resource data 308 of the machine 302 such that the resource data determining module 306 may adjust the threshold the resource data 308 must satisfy for the sensor module 310 to be employed thereby conserving resources of the machine 302 for performance of control operations.

In some embodiments, the remote server 320 may be configured to receive sensor data 314 from the machine 302. For example, the sensor data 314 may be cached at the remote server 320 via push and/or pull caching. Distributed caching of sensor data 314 using the remote server 320 may minimize or reduce latency in the distribution of sensor data 314 and/or the ancillary tracking output 318 generated by the analyzing module 316 using the sensor data 314 back to the machine 302 and/or to one or more third parties.

In some embodiments, the remote server 320 may be part of a cloud-based network environment. A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to a remote server(s), a core server(s) may designate at least a portion of the functionality to the remote server(s). A cloud-based network environment may be private (e.g., limited to a single organization), may be public (e.g., available to many organizations), and/or a combination thereof (e.g., a hybrid cloud environment).

By way of example, the system 300 may include a semi-autonomous boat as an example machine 302 and a remote server 320 that is located on a dock (or at a more remote location communicatively coupled via cellular, Wi-Fi, and/or the Internet). In such an example, the boat may include a control operations module 304 configured to perform control operations such as steering the boat, navigating, adjusting speed, detecting and avoiding collisions, etc. The control operations module 304 may be configured to use one or more sensors (e.g., GPS sensor, SONAR sensor, etc.) on the boat to perform control operations. A user of the boat (e.g., skipper, helmsperson, captain, crewmember, passenger, etc.) may intend to use the boat for travel purposes (e.g., transportation from one side of a lake to another) such that the control operations module 304 may aid the user in realizing her travel purposes (e.g., the boat may steer itself so the user can enjoy being a passenger for at least a portion of the trip).

Continuing the example, the boat may include resources such as fuel and electricity that may be used in operation of the boat. The boat may have a resource data determining module 306 configured to monitor the resource data 308 of the boat. The resource data 308 may include data representing how much of the boat's resources are available and/or are predicted to be available given a certain set of conditions (e.g., the resource data 308 may indicate that the boat has enough gasoline to operate on calm waters with no wind for at least 20 miles). In response to the resource data determining module 306 determining that the resource data 308 satisfies a threshold (e.g., that the boat can operate for at least the distance between two docks of a lake), a sensor module 310 configured with one or more sensors may be used to obtain sensor data 314 of an environmental feature 312 such as images of a particular species of fish present in the lake or pH measurements of the water. The environmental feature 312 may be of little or no interest to the user(s) of the boat and/or may not be relevant to the performance of control operations by the boat (e.g., the pH of the water of the lake is unlikely to impact the ability of the boat to travel from one dock to the other). Thus, the environmental feature 312 may be considered ancillary.

Further continuing the example, since the boat may experience poor network connectivity while in the middle of a lake, the boat may be configured to store the sensor data 314 until the boat is near the dock with the remote server 320. In this example, once the boat has docked, the sensor data 314 may be communicated to the remote server 320. The remote server 320 may include an analyzing module 316 configured to obtain the sensor data 314 and generate an ancillary tracking output 318 that identifies the environmental feature 312. Using the example where the environmental feature 312 was a particular species of fish, the ancillary tracking output 318 may be a count of how many of that species of fish compared to other species of fish the sensors on the boat were able to capture during that trip. In such an example, while the amount of a particular fish species in the lake may not impact the travel of the boat across the lake, such an ancillary tracking output 318 may be of interest to a team studying the impacts of overfishing in that lake on that species of fish.

In this example, the analyzing module 316 being located as part of the remote server 320 on the dock may provide a benefit to the boat in that resources of the boat such as electricity may not be used to generate the ancillary tracking output 318, rather the resources of the remote server 320 may be used. As an alternative example, the system 300 may not have included a remote server 320 such that the analyzing module 316 may be configured to generate the ancillary tracking output 318 as part of/onboard the boat. Additionally, as another example, the boat may have been configured with an analyzing module 316 onboard but may still send the sensor data 314 to a remote server 320 depending on the resource data 308 of the boat, the type of sensor data 314 to be analyzed, the location of the boat relative to a remote server 320, and/or for any other reason such as to optimize performance of ancillary environmental monitoring.

In some embodiments, communicating the sensor data 314 obtained by the machine 302 to the remote server 320 may depend on factors such as what type and the amount of data is included in the sensor data 314, the location of the machine 302 relative to the remote server 320, the computing resources of the machine 302 relative to the remote server 320, etc. For example, the machine 302 may be an autonomous vehicle with hardware such as CPUs, GPUs, etc. capable of processing sensor data 314 for safe driving. In such an example, the autonomous vehicle may not have the computing resources available to train and/or run a large language model (LLM) or another AI model that may use a significant amount of computing resources. As such, by communicating the resource data 314 to the remote server 320, the autonomous vehicle may be able to conserve computing resources while still permitting the ancillary tracking output 318 to be generated.

In some embodiments, the machine 302 may group sensor data 318 based on type of data and communicate each type of data to a particular analyzing module 316. For example, if an autonomous vehicle obtains both LiDAR data and image data, the autonomous vehicle may send all the LiDAR data to an analyzing module 316 configured to use an AI model for analyzing point cloud data representations and may send all the image data to a different analyzing module 316 that is configured to use an AI model, such as a convolutional neural network (CNN), for extracting features from images. In some embodiments, the remote server 320 may aid in this process as the analyzing modules 316 may not be located in, on, or near an appropriate analyzing module 316. In these and other embodiments, the remote server 320 may be used by itself or in connection with additional servers, machines, and/or devices to communicate sensor data 314 from a machine 302 to an analyzing module 316. To continue the previous example, the autonomous vehicle may be close enough and have enough network connectivity to send all of the data (e.g., both LiDAR data and image data) to a remote server 320 that is not configured itself with an analyzing module 316. In response to obtaining the sensor data 314, the remote server 320 may send the sensor data 314 to other servers, machines, devices, etc. until appropriate analyzing modules 316 are located such that ancillary tracking outputs 318 may be generated.

In some embodiments, the remote server 320 may improve the system 300 by coordinating between machines 302. For example, the remote server 320 may be in communication with more than one machine 302 such that in response to a first machine having an obstructed view of an environmental feature 312 of interest, the remote server 320 may communicate/prompt a second machine to also obtain sensor data 314 with respect to that environmental feature. As another example, the remote server 320 may be configured to prompt a machine 302 that is stopped at an intersection to capture a picture of a sign with graffiti on it instead of a different machine 302 that only passes by the sign while traveling at 35 MPH. In these and in other embodiments, the remote server 320 may improve the system 300 by allowing the machine 302 to offload at least a portion of its onboard data processing such that more resources of the machine 302 can be used to generate ancillary tracking outputs 318 of environmental features 312.

Modifications, additions, or omissions may be made to FIG. 3 without departing from the scope of the present disclosure. For example, the amount and/or type of resource data 308 and/or sensor data 314, the number of modules configured to perform various control operations, and/or the number of ancillary tracking outputs 318 may vary. Additionally, although illustrated using a semi-autonomous boat, this is not intended to be limiting. The system 300 may be implemented using any machine (e.g., an ego-machine such as an autonomous car). The specifics given and discussed are to help provide explanation and understanding of concepts of the present disclosure and are not meant to be limiting.

In addition, in some embodiments, the remote server 320 may include multiple servers (e.g., a server farm) such that reference to the “remote server 320” or other “remote servers” in the present disclosure, may generally refer to one or more servers individually and/or collectively. Further, although a remote server is specifically described, it is also understood that any other appropriate computing system and/or computing devices that may be able to perform the operations described with respect to the remote server 320 may be used in certain embodiments where applicable.

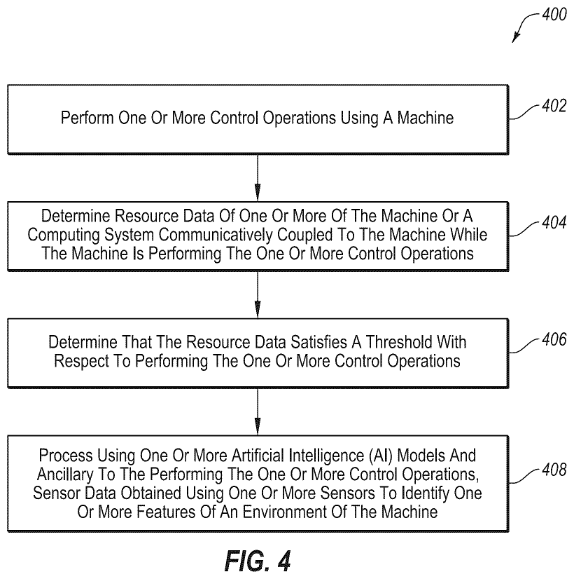

FIG. 4 is a flow diagram showing a method 400 for obtaining sensor data based on resource data of a machine, in accordance with one or more embodiments of the present disclosure. The method 400 may include one or more blocks 402, 404, 406, and 408. Although illustrated with discrete blocks, the operations associated with one or more of the blocks of the method 400 may be divided into additional blocks, combined into fewer blocks, or eliminated, depending on the particular implementation.

In some embodiments, the method 400 may include block 402. At block 402, a machine (e.g., an ego-machine) may perform operations related to control (“control operations”). In some embodiments, the control operations may correspond to the nature of the machine (e.g., an automobile on land may operate differently than a drone in the air) and/or the preferences of a user, controller, programmer, etc. For example, the user may set the machine to avoid toll roads such that navigation operations performed related to travelling to a specified location may be altered to prevent the machine from selecting a route involving tolls. In some embodiments, the one or more control operations corresponding to block 402 may be performed as described in the present disclosure, such as described with respect to machine 122 of FIG. 1B and/or machine 302 of FIG. 3.

At block 404, resource data of the machine and/or a computing system communicatively coupled to the machine may be determined. In some embodiments, the resource data may be determined in response to the machine receiving a prompt to perform tracking of one or more environmental features (e.g., to determine if there are enough resources to both perform control operations and the ancillary tracking). Additionally or alternatively, the resource data may be determined as part of the routine functions of the machine. In some embodiments, one or more operations corresponding to block 404 may be performed as described in the present disclosure, such as described with respect to the resource data determining module 306 of FIG. 3.

At block 406, the method may additionally include determining whether the resource data satisfies a threshold with respect to performing the control operations. In some embodiments, the threshold may be selected by the user, controller, programmer, etc., based on personal preference. Additionally or alternatively, the threshold may be based on optimizing the machine for a specified purpose (e.g., travel the greatest distance without having to charge, obtain as many images of native wildlife so long as there is computing memory space available, etc.). In some embodiments, satisfying the threshold may include exceeding the threshold (e.g., threshold is satisfied when more than a specified amount of vehicle battery remains). Alternatively, satisfying the threshold may include being below the threshold (e.g., threshold is satisfied when fewer than a specified number of system errors have been detected). In some embodiments, the threshold may be satisfied within a range of values (e.g., threshold is satisfied when the internal temperature of the machine is between 18° C. and 23° C.). In some embodiments, one or more operations corresponding to block 406 may be performed as described in the present disclosure, such as described with respect to the resource data determining module 306 of FIG. 3.

At block 408, sensor data obtained using one or more sensors to identify one or more features of an environment of the machine may be processed using one or more artificial intelligence (AI) models and ancillary to performing the one or more control operations. In these and other embodiments, the sensor data may indicate a feature of an environment of the machine (e.g., an environmental feature) and/or may correspond to a state of one or more features of the environment. Additionally or alternatively, block 408 may include sending data representative of the one or more features to one or more remote computing devices (e.g., a remote server, an edge server, etc.). In some embodiments, obtaining the sensor data may be based on one or more levels of confidence that the sensor data indicates one or more features of interest in an environment. In some embodiments, the sensor data may include image data. In some embodiments, the AI model may include a machine learning (ML) model, a neural network, a large language model (LLM), a vision language model (VLM), and/or any other AI model. In these and other embodiments, the processing of the sensor data in such a manner may be ancillary to performing the control operations. In some embodiments, processing the sensor data may be performed at and/or by the machine or by one or more components of the machine (e.g., the computing system of the machine, an analyzing module integrated with the machine, etc.). Additionally or alternatively, processing the sensor data may be performed at and/or by a remote computing device such as a remote server or by another device independent of the machine (e.g., a second machine). In some embodiments, processing using the one or more AI models may include performing objection localization and/or image classification with respect to image data. In some embodiments, at least a portion of the AI model may correspond to a remote server. In some embodiments, the method 400 may include sending at least a portion of the sensor data (e.g., data representative of the one or more features of the environment) to the remote server for processing by at least the portion of the AI model corresponding to the remote server. In these and other embodiments, the sensor data may be sent to the remote server based at least on resource data, relative location of the machine with respect to the remote server, and/or network connectivity of the machine. In some embodiments, the frame rate corresponding to processing the sensor data may be adjusted based at least on the resource data. In some embodiments, one or more operations corresponding to block 408 may be performed as described in the present disclosure, such as described with respect to the sensor 124 of FIG. 1B, the sensor module 310 of FIG. 3, the analyzing module 104 of FIG. 1A, the analyzing module 130 of FIG. 1B, and/or the analyzing module 316 of FIG. 3.

Modifications, additions, or omissions may be made to the method 400 and/or one or more operations included in the method 400 without departing from the scope of the present disclosure. For example, the operations corresponding to the method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments. For example, the method 400 may include notifying a third party of environmental features identified by the AI model in response to the environmental features having been identified as being of interest to the third party.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more CPU(s), system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, and/or to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems sensor(s) 558 (e.g., Global Positioning System sensor(s)), RADAR sensor(s) 560, ultrasonic sensor(s) 562, LiDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) 546 (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the HD map 522 of FIG. 5C), location data (e.g., the location of the vehicle 500, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524, which may use one or more wireless antenna(s) 526 and/or modem(s) to communicate over one or more networks. For example, the network interface 524 may be capable of communication over LTE, WCDMA, UMTS, GSM, CDMA2000, etc. The wireless antenna(s) 526 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward-facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may any number of wide-view cameras 570 on the vehicle 500. In addition, long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

One or more stereo cameras 568 may also be included in a front-facing configuration. The stereo camera(s) 568 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360-degree camera(s), and/or the like. For example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround-view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C is illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting, and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected to both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating-point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating-point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LiDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe-stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LiDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always-on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528, which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPD (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data, in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250m range. The RADAR sensor(s) 560 may help in distinguishing between static and moving objects and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surrounding at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 160m (front) or 80m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5m, 4m). The ultrasonic sensor(s) 562 may operate at functional safety levels of ASIL B.

The vehicle 500 may include LiDAR sensor(s) 564. The LiDAR sensor(s) 564 may be used for object and pedestrian detection, emergency braking, collision avoidance, and/or other functions. The LiDAR sensor(s) 564 may be functional safety level ASIL B. In some examples, the vehicle 500 may include multiple LiDAR sensors 564 (e.g., two, four, six, etc.) that may use Ethernet (e.g., to provide data to a Gigabit Ethernet switch).

In some examples, the LiDAR sensor(s) 564 may be capable of providing a list of objects and their distances for a 360-degree field of view. Commercially available LiDAR sensor(s) 564 may have an advertised range of approximately 100m, with an accuracy of 2cm-3cm, and with support for a 100Mbps Ethernet connection, for example. In some examples, one or more non-protruding LiDAR sensors 564 may be used. In such examples, the LiDAR sensor(s) 564 may be implemented as a small device that may be embedded into the front, rear, sides, and/or corners of the vehicle 500. The LiDAR sensor(s) 564, in such examples, may provide up to a 120-degree horizontal and 35-degree vertical field-of-view, with a 200m range even for low-reflectivity objects. Front-mounted LiDAR sensor(s) 564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LiDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network that is trained and thus reduces the risk of false positives, as described herein.

The vehicle 500 may further include the infotainment SoC 530 (e.g., an in-vehicle infotainment system (IVI)). Although illustrated and described as an SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands-free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe-stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

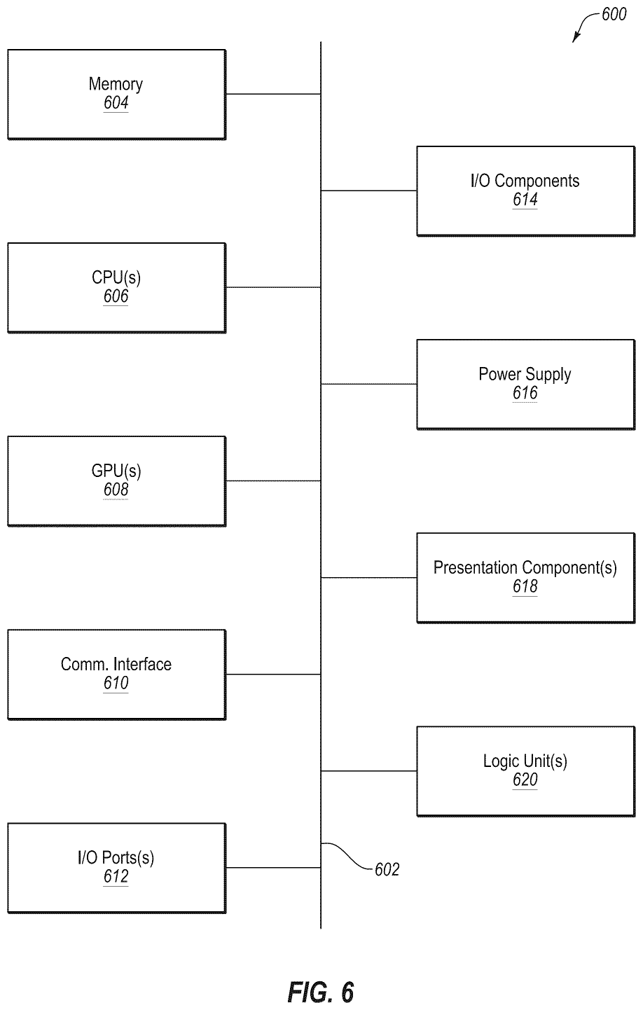

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, include wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present invention is illustrated, for example, according to various aspects described below. Various examples of aspects of the subject technology are described as numbered examples (1, 2, 3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1. A method may include:
performing one or more control operations using a machine;
determining resource data of one or more of the machine or a computing system communicatively coupled to the machine while the machine is performing the one or more control operations;
in response to determining that the resource data satisfies a threshold with respect to performing the one or more control operations, processing using one or more artificial intelligence (AI) models and ancillary to the performing the one or more control operations, sensor data obtained using one or more sensors to identify one or more features of an environment of the machine; and
sending data representative of the one or more features to one or more remote computing devices.

The method included in Example 1, wherein the one or more control operations include one or more of: route planning, navigation, perception, localization, actuation, or communication.

The method included in Example 1, wherein the resource data includes one or more of: power level, battery level, fuel level, engine temperature, tire pressure, oil level, brake fluid level, available memory, disk space, network bandwidth, temperature, or system load average.

The method included in Example 1, wherein the one or more features of the environment correspond to a state of at least one of: pollution, light, graffiti, litter, plants, wildlife, bodies of water, fires, atmospheric conditions, people, or vehicles.

The method included in Example 1, wherein the sensor data includes image data, and wherein the processing using the one or more AI models includes performing one or more of object localization or image classification with respect to the image data.

The method included in Example 1, further comprising notifying a third party of the one or more features of the environment based at least on the one or more features of the environment being identified as being of interest to the third party.

The method included in Example 1, wherein at least a portion of the one or more AI models corresponds to a remote server, and the method further comprises sending at least a portion of the sensor data to the remote server for processing by at least the portion of the AI model corresponding to the remote server.

The method included in Example 1, wherein the sensor data is sent to a remote server based at least on one or more of: the resource data, a relative location of the machine with respect to the remote server, or network connectivity of the machine.

The method included in Example 1, wherein a frame rate corresponding to the processing using one or more AI models is adjusted based at least on the resource data.

Example 2. At least one processor may include:
one or more circuits to:
in response to a machine performing one or more control operations:
obtain data using one or more sensors communicatively coupled to the machine; and
generate a tracking output based on the data using one or more artificial intelligence (AI) models, wherein the tracking output represents a feature of an environment of the machine.

The at least one processor of Example 2, wherein the one or more control operations include one or more of: route planning, navigation, perception, localization, actuation, or communication.

The at least one processor of Example 2, wherein the resource data includes one or more of: power level, battery level, fuel level, engine temperature, tire pressure, oil level, brake fluid level, available memory, disk space, network bandwidth, temperature, or system load average.

The at least one processor of Example 2, wherein the feature of the environment of the machine includes one or more of: pollution, light, graffiti, litter, plants, wildlife, bodies of water, fires, atmospheric conditions, people, or vehicles.

The at least one processor of Example 2, wherein the sensor data includes image data, and wherein the processing the sensor data includes performing one or more of object localization or image classification with respect to the image data.

The at least one processor of Example 2, wherein the one or more AI models include one or more of: a machine learning (ML) model, a neural network, a large language model (LLM), or a vision language model (VLM).

The at least one processor of Example 2, wherein the one or more circuits notify a third party of the feature of the environment based at least on the feature of the environment being identified as being of interest to the third party.

The at least one processor of Example 2, wherein at least a portion of the one or more AI models corresponds to a remote server, and the one or more circuits send at least a portion of the sensor data to the remote server for processing by the portion of the one or more AI models corresponding to the remote server.

The at least one processor of Example 2, wherein the sensor data is sent to a remote server based at least on one or more of: the resource data, relative location of the machine with respect to the remote server, or network connectivity of the machine.

Example 3. A system may include:
one or more processors to perform operations comprising:
performing one or more control operations using a machine;
determining resource data of one or more of the machine or a computing system communicatively coupled to the machine while the machine is performing the one or more control operations; and
in response to determining that the resource data satisfies a threshold with respect to performing the one or more control operations, processing using one or more artificial intelligence (AI) models and ancillary to the performing the one or more control operations, sensor data obtained using one or more sensors to identify one or more features of an environment of the machine,
wherein the one or more control operations include one or more of: route planning, navigation, perception, localization, actuation, or communication,
wherein the resource data includes one or more of: power level, battery level, fuel level, engine temperature, tire pressure, oil level, brake fluid level, available memory, disk space, network bandwidth, temperature, or system load average, and
wherein the one or more features of the environment include one or more of: pollution, light, graffiti, litter, plants, wildlife, bodies of water, fires, atmospheric conditions, people, or vehicles.

The system of Example 3, wherein the system may include at least one of:
a control system for an autonomous or semi-autonomous machine;
a perception system for an autonomous or semi-autonomous machine;
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM),
a system for performing generative AI operations using a vision language model (VLM),
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.

What is claimed is:

1. A method comprising:
performing one or more control operations using a machine;
determining resource data of one or more of the machine or a computing system communicatively coupled to the machine while the machine is performing the one or more control operations;
in response to determining that the resource data satisfies a threshold with respect to performing the one or more control operations, processing using one or more artificial intelligence (AI) models and ancillary to the performing the one or more control operations, sensor data obtained using one or more sensors to identify one or more features of an environment of the machine; and
sending data representative of the one or more features to one or more remote computing devices.

2. The method of claim 1, wherein the one or more control operations include one or more of: route planning, navigation, perception localization, actuation, or communication.

3. The method of claim 1, wherein the resource data includes one or more of: power level, battery level, fuel level, engine temperature, tire pressure, oil level, brake fluid level, available memory, disk space, network bandwidth, temperature, or system load average.

4. The method of claim 1, wherein the one or more features of the environment correspond to a state of at least one of: pollution, light, graffiti, litter, plants, wildlife, bodies of water, fires, atmospheric conditions, people, or vehicles.

5. The method of claim 1, wherein the sensor data includes image data, and wherein the processing using the one or more AI models includes performing one or more of object localization or image classification with respect to the image data.

6. The method of claim 1, further comprising notifying a third party of the one or more features of the environment based at least on the one or more features of the environment being identified as being of interest to the third party.

7. The method of claim 1, wherein at least a portion of the one or more AI models corresponds to a remote server, and the method further comprises sending at least a portion of the sensor data to the remote server for processing by at least the portion of the AI model corresponding to the remote server.

8. The method of claim 7, wherein the sensor data is sent to the remote server based at least on one or more of: the resource data, a relative location of the machine with respect to the remote server, or network connectivity of the machine.

9. The method of claim 1, wherein a frame rate corresponding to processing the sensor data is adjusted based at least on the resource data.

10. At least one processor, comprising:
one or more circuits to:
in response to a machine performing one or more control operations:
obtain data using one or more sensors communicatively coupled to the machine; and
generate a tracking output based on the data using one or more artificial intelligence (AI) models, wherein the tracking output represents a feature of an environment of the machine.

11. The at least one processor of claim 10, wherein the one or more control operations include one or more of: route planning, navigation, perception, localization, actuation, or communication.

12. The at least one processor of claim 10, wherein the machine performs the one or more control operations in response to resource data satisfying a threshold with respect to the one or more control operations, wherein the resource data includes one or more of: power level, battery level, fuel level, engine temperature, tire pressure, oil level, brake fluid level, available memory, disk space, network bandwidth, temperature, or system load average.

13. The at least one processor of claim 10, wherein the feature of the environment of the machine includes one or more of: pollution, light, graffiti, litter, plants, wildlife, bodies of water, fires, atmospheric conditions, people, or vehicles.

14. The at least one processor of claim 10, wherein the sensor data includes image data, and wherein the processing the sensor data includes performing one or more of object localization or image classification with respect to the image data.

15. The at least one processor of claim 10, wherein the one or more AI models include one or more of: a machine learning (ML) model, a neural network, a large language model (LLM), or a vision language model (VLM).

16. The at least one processor of claim 10, wherein the one or more circuits notify a third party of the feature of the environment based at least on the feature of the environment being identified as being of interest to the third party.

17. The at least one processor of claim 10, wherein at least a portion of the one or more AI models corresponds to a remote server, and the one or more circuits send at least a portion of the sensor data to the remote server for processing by the portion of the one or more AI models corresponding to the remote server.

18. The at least one processor of claim 17, wherein the sensor data is sent to the remote server based at least on one or more of: resource data, relative location of the machine with respect to the remote server, or network connectivity of the machine.

19. A system comprising:
one or more processors to perform operations comprising:
performing one or more control operations using a machine;
determining resource data of one or more of the machine or a computing system communicatively coupled to the machine while the machine is performing the one or more control operations; and
in response to determining that the resource data satisfies a threshold with respect to performing the one or more control operations, processing using one or more artificial intelligence (AI) models and ancillary to the performing the one or more control operations, sensor data obtained using one or more sensors to identify one or more features of an environment of the machine,
wherein the one or more control operations include one or more of: route planning, navigation, perception, localization, actuation, or communication,
wherein the resource data includes one or more of: power level, battery level, fuel level, engine temperature, tire pressure, oil level, brake fluid level, available memory, disk space, network bandwidth, temperature, or system load average, and
wherein the one or more features of the environment include one or more of: pollution, light, graffiti, litter, plants, wildlife, bodies of water, fires, atmospheric conditions, people, or vehicles.

20. The system of claim 19, wherein the system comprises at least one of:
a control system for an autonomous or semi-autonomous machine;
a perception system for an autonomous or semi-autonomous machine;
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM),
a system for performing generative AI operations using a vision language model (VLM),
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center,
a system for performing hardware testing using simulation;
a system for synthetic data generation;
a collaborative content creation platform for 3D assets; or
a system implemented at least partially using cloud computing resources.
